(19) United States
(12) Patent Application Publication
(10) Pub. No.: US 2023/0048504 A1
(43) Pub. Date: Feb. 16, 2023

(54) DYNAMIC ALLOCATION OF SHARED BUS LANES

(71) Applicant: Hewlett-Packard Development Company, L.P., Spring, TX (US)

(72) Inventors: Peter Seiler, Fort Collins, CO (US); Justin Barth, Fort Collins, CO (US); Shane Ward, Fort Collins, CO (US)

(73) Assignee: Hewlett-Packard Development Company, L.P., Spring, TX (US)

(21) Appl. No.: 17/794,126

(22) PCT Filed: Feb. 18, 2020
(86) PCT No.: PCT/US2020/018569

§ 371 Date: Jul. 20, 2022

(51) Int. Cl. G06F 13/362; G06F 13/38; G06F 13/42

(52) U.S. Cl. CPC G06F 13/362; G06F 13/385; G06F 13/4221

(57) ABSTRACT

Examples are described herein for dynamically allocating shared bus lanes provided by a peripheral component bridge. A multiplexor may be operably coupled with the bridge via the shared bus lanes. A plurality of peripheral component slots may each be operably coupled with the multiplexor via a respective plurality of peripheral bus lanes. The multiplexor may multiplex the shared bus lanes to multiple different peripheral component slots. Circuitry may: interrogate each of the peripheral component slots to obtain information about a modular component installed in the peripheral component slot, wherein the information about the modular component includes a usable range of bus lanes and a transmission speed capability; and cause the multiplexor to dynamically allocate the number of shared bus lanes to the respective pluralities of peripheral bus lanes of the peripheral component slots based on the usable ranges and transmission speed capabilities of the installed modular components.

### BACKGROUND

Modular hardware components can be removably installed into peripheral component slots of a computing device to provide the computing device with additional capabilities and/or resources. These modular hardware components can include, for instance, network interface cards (“NICs”), computer-readable media (e.g., solid state storage devices, random-access memory), universal serial bus (“USB”) cards, graphics cards, compute cards, accelerator cards, etc. Each peripheral component slot includes electrical contact(s) that electrically couple an installed modular hardware component (often referred to as a “card”) to a processor and/or other components of the computing device, e.g., over one or more shared buses provided by a peripheral component bridge. In many cases these peripheral component slots are designed and manufactured according to a standard such as the peripheral component interconnect (“PCI”) or PCI express (“PCIe”) standards, and the peripheral component bridge takes the form of a “host bridge” (for PCI) or “root complex” (for PCIe).

### BRIEF DESCRIPTION OF THE DRAWINGS

Features of the present disclosure are illustrated by way of example and not limited in the following figure(s), in which like numerals indicate like elements.

FIG. 1 is a drawing of an example environment in which selected aspects of the present disclosure may be implemented.

FIG. 2 is a drawing of an example scenario in which disclosed techniques may be practiced.

FIG. 3 is a drawing of an example scenario in which disclosed techniques may be practiced.

FIG. 4 is a drawing of an example scenario in which disclosed techniques may be practiced.

FIG. 5 depicts an example method for practicing selected aspects of the present disclosure.

FIG. 6 depicts an example computer-readable medium with instructions to carry out selected aspects of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Additionally, it should be understood that the elements depicted in the accompanying figures may include additional components and that some of the components described in those figures may be removed and/or modified without departing from scopes of the elements disclosed herein. It should also be understood that the elements depicted in the figures may not be drawn to scale and thus, the elements may have different sizes and/or configurations other than as shown in the figures.

Different modular hardware components may have different capabilities and/or configurations. For example, one modular hardware component may include four electrical bus lanes (a.k.a, “x4” in PCIe parlance), another modular hardware component may include eight electrical bus lanes (“x8”), and so on. Also, different modular hardware components may have different transmission speed capabilities. For example, one PCIe component may belong to the PCIe 4.0 generation, and therefore may be capable of up to 16 gigatransfers per second (GT/s) per lane. Another PCIe component may belong to the PCIe 5.0 generation, and therefore may be capable of up to 32 GT/s per lane. And so on.

In most computing devices, electrical bus lanes or “routes” between peripheral component slots and other resources of the computing device (e.g., processor) tend to be static. For example, a computing device may include a mixture of x1, x4, x8, and x16 peripheral slots. Additionally, like modular hardware components, the peripheral component slots can also have limited transmission speed capabilities. Consequently, many users may struggle installing modular hardware devices in a manner that maximizes bandwidth between one or more of the modular hardware components and other resources of the computing device.

Accordingly, examples are described herein for dynamically allocating a number of shared bus lanes to a plurality of peripheral component slots, and more particularly, to the respective pluralities of peripheral bus lanes of the plurality of peripheral component slots. This dynamic allocation may be performed with various goals in mind, such as maximizing bandwidth utilization between each of the plurality of installed modular components and a peripheral component bridge, or between a selected one of the plurality of installed modular components (e.g., a component heavily utilized by a user) and the peripheral component bridge.

In various examples, the dynamic allocation may be based on a variety of different signals or factors. In some examples, the dynamic allocation may be based on information about peripheral hardware components that are installed in peripheral component slots. This information may include, for instance, a usable range of bus lanes by the modular component or a transmission speed capability of the modular component.

A modular component's usable range is a range between a maximum number of lanes that the modular component can use at full capacity and a minimum number of lanes that the modular component can use and still operate (at least to some threshold standard). For example, a NIC may be designed to operate as an x8 device in optimal conditions and can also operate as low as an x4 device. A transmission speed capability of a modular component may represent a maximum bit transfer rate. Examples of transmission speed capabilities were described previously with regard to different generations of PCIe components.

In some examples, the dynamic allocation may be based on aspects of the peripheral component slot. For example, PCIe slots may be rated for higher transmission speeds than others, e.g., because they are closer to the PCIe root complex, resulting in less channel loss. Other examples of limited transmission speeds may be related to limitations of a given root complex, the presence of signal conditioners (e.g. redrivers or retimers), or backplane or cable limitations.

In some examples, the dynamic allocation may be based on historical usage data associated with each of the modular components installed in a computing system and/or with usage data of the computing system based on a user's unique workflow. For example, a graphic designer may rely heavily on the full processing capabilities of a graphics PCIe card, and may be less concerned that a PCIe NIC achieve peak performance (maybe there is a network bottleneck elsewhere that limits the NIC's performance regardless). These preferences may be set by the graphical designer manually, or may be detected over time (e.g., the graphic designer tends to utilize the PCIe graphics card far more frequently and heavily than the NIC). In either case, allocation of PCIe lanes may be prioritized to the graphics PCIe card over the NIC.

In some examples, the dynamical allocation may be based on a priori and/or a posteriori knowledge about performance of the modular component. A priori knowledge about the modular component may include, for instance, knowledge about how the modular component is intended to work, e.g., based on knowledge about how the component's manufacturer designed the component to operate under particular circumstances. This a priori knowledge may be obtained from, for instance, technical specifications, reverse engineering, and/or other information associated with the modular component. A posteriori knowledge, by contrast, may be obtained through observation of and/or experience with a modular component, and may include, for instance, observations about the modular component's performance, empirical data gathered about the modular component's performance, and so forth, which may in some instances be informed through performing a specific workload.

For example, a priori and/or a posteriori knowledge may reveal that a particular modular component operates in particular ways depending on how many peripheral component lanes they are allocated. Suppose there is a surplus of shared bus lanes available, and hence, a flexible range of shared bus lanes are available for allocation to the modular component. That modular component may be known to fully utilize the allocated lanes so that it can perform optimally and also have headroom for taking on transient workload influxes. However, given fewer lanes, the modular component may still be able to provide similar performance, albeit with less headroom to take on transient workflow influxes. But, in some cases these transient workload influxes may be uncommon for the component or the system in which it is installed to experience, and therefore may represent a reasonable compromise.

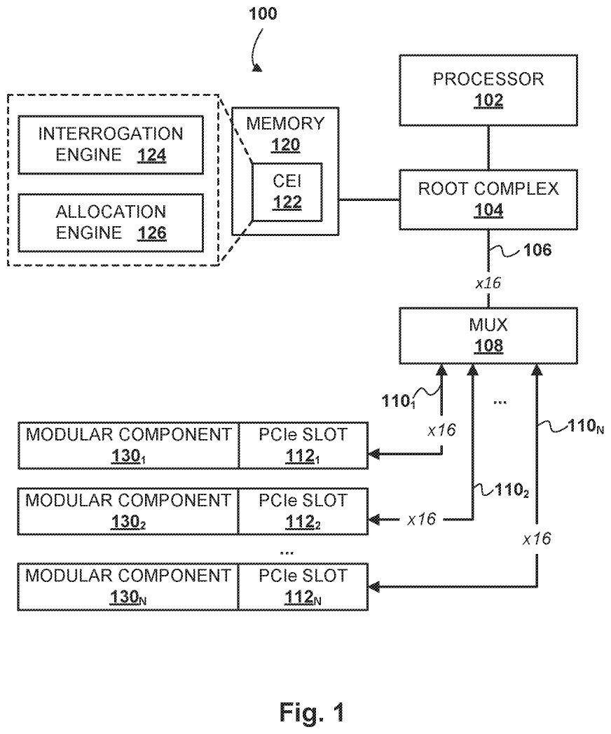

FIG. 1 shows a system 100 configured with selected aspects of the present disclosure to facilitate dynamic allocation of shared bus lanes. In FIG. 1 and elsewhere herein, various components are described as PCIe components. However, this is not meant to be limiting, and techniques described herein are applicable outside of the PCIe context.

In FIG. 1, a processor 102 may be operably coupled (e.g., via a bus) with a peripheral component bridge, which in FIG. 1 takes the form of a PCIe root complex 104. PCIe root complex 104 may provide and/or be coupled with a plurality of shared bus lanes 106, and may also be coupled with various types of routing circuitry. In some examples, the routing circuitry may take the form of a multiplexor (“MUX” in FIG. 1) 108. In FIG. 1, shared bus lanes 106 includes sixteen (x16) lanes, but this is not meant to be limiting. In some examples, the shared bus lanes 106 may electrically couple the root complex 104 to multiplexor 108 on the same printed circuit assembly (“PCA”), through a backplane or cabled interconnect, or even through an external backplane or cabled interconnect.

A plurality of peripheral component slots in the forms of PCIe slots 112_{1-N} (N being a positive integer) are also provided in FIG. 1. PCIe slots 112_{1-N} are operably coupled with multiplexor 108 via respective pluralities or sets 110_{1-N} of peripheral bus lanes. Each set 110 represents a maximum number of lanes that can be utilized by the respective PCIe slot 112, but less than this maximum number of lanes can be used. For example, first PCIe slot 112₁ is operably coupled with multiplexor 108 via a set 110₁ of sixteen lanes (x16). Second PCIe slot 112₂ is also operably coupled with multiplexor 108 via a set 110₂ of sixteen lanes (x16). And so on. While in FIG. 1 each PCIe slot has the same number of lanes (x16), this is not meant to be limiting; different peripheral component slots may have different numbers of lanes.

In various examples, multiplexor 108 multiplexes the x16 shared bus lanes 106 to multiple different PCIe slots 112. Consequently, and as is evident in FIG. 1, there are a greater number of total PCIe slot lanes (at least 3×16=48 lanes) than there are shared bus lanes 106 (x16) from multiplexor 108 to PCIe root complex 104. Examples described herein leverage this additional flexibility to dynamically allocate peripheral component slot lanes in a thoughtful and efficient manner, e.g., with various different potential goals in mind (e.g., maximize overall bandwidth, or bandwidth to a particular modular component).

In various examples, various types of circuitry 122 may be provided to dynamically allocate the x16 shared bus lanes 106 across multiple PCIe slots 112_{1-N}. In some examples, circuitry 122 may be implemented using hardware, and may take the form of, for instance, a field-programmable gate array (“FPGA”) or an application-specific integrated circuit (“ASIC”).

In other examples, such as in FIG. 1, circuitry 122 takes the form of processor 102 combined with computer-executable instructions (“CEI” in FIG. 1) that are stored in memory 120 and that are executable by processor 102. In some such examples, circuitry 122 may form part of a basic input/output system (“BIOS”). Memory 120 may take various forms, include but not limited to random-access memory (“RAM”), read-only memory (“ROM”) having its contents fixed at manufacture, a FLASH memory whose contents may be modified post-manufacture, or other type of volatile or non-volatile memory suitable for storing computer-executable instructions, for example, programmable ROM (“PROM”), electrically erasable PROM (“EEPROM”), magnetoresistive random-access memory (“MRAM”), or ferroelectric memory.

In some examples, circuitry 122 may, e.g., by way of an interrogation engine 124, “interrogate” or “train” each of the PCIe slots 112_{1-N} to obtain information about a modular component 130 installed in the PCIe slot 112. As used herein, to “interrogate” a PCIe slot 112 means to interact with it electrically to ascertain information about it. In some examples the interrogation of multiple PCIe slots 112 may be accomplished by configuring multiplexor 108 to iterate through each PCIe slot 112, supplying all (x16) shared bus lanes 106 at once during each iteration. A link width (e.g. the number of PCIe lanes electrically connected) and transmission speed capability (e.g. the PCIe generation supported, for example, PCIe G3 at 8 GTps, PCIe G4 at 16 GTps, and so on) can be ascertained. In other words, the BIOS learns what link types can be supplied to the modular component 230 to maximize its bandwidth. The above process may be repeated for each PCIe slot 112.

The information about the modular component 130 learned through this interrogation may include, for instance, a usable range of bus lanes, a transmission speed capability of the modular component 130, a priori and/or a posteriori knowledge about performance of the modular component 130, and/or historical usage of the modular component 130 within a system, by a particular user, and/or across a population of users. Based in this information, circuitry 122 may, e.g., by way of an allocation engine 126, cause multiplexor 108 to dynamically allocate the number (x16 in FIG. 1) of shared bus lanes 106 to the respective pluralities 110_{1-N} of peripheral bus lanes of the PCIe slots 112_{1-N}.

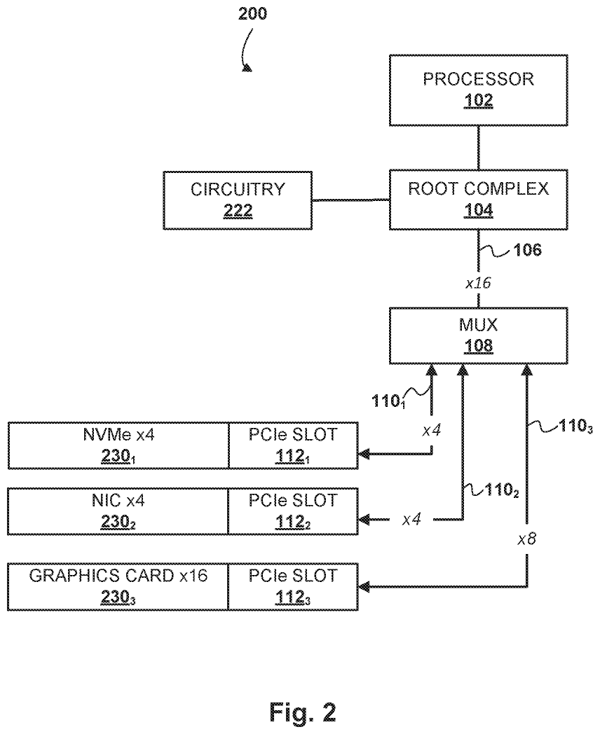

FIG. 2 demonstrates an example in which three particular modular components 230 are installed in a system 200. System 200 includes many of the same components as system 100 of FIG. 1, except that now there are three PCIe slots 112₁₋₃, rather than an indeterminate number (N) of lanes as shown in FIG. 1. Also, circuitry 222 is not depicted as computer-executable instructions, as was circuitry 122 in FIG. 1, but instead is depicted generically to indicate that it may be implemented using any combination of hardware and computer-executable instructions.

In FIG. 2, a first modular component 230₁ takes the form of a non-volatile memory express (“NVMe”) host controller interface for use with, for instance, a solid-state memory (not depicted, e.g., a hard drive). First modular component 230₁ uses four (x4) PCIe lanes by default. A second modular component 230₂ takes the form of NIC. Second modular component 230₂ also uses four (x4) PCIe lanes by default. A third modular component 230₃ takes the form of a graphics card that uses sixteen (x16) PCIe lanes.

In various examples, circuitry 222 may interrogate the PCIe slots 112₁₋₃ to obtain this information about modular components 230₁₋₃. In some examples, when system power is first applied, a power on self-test (“POST”) is initiated. During the POST, circuitry 222 may discover and configure modular components that are removably installed in PCIe slots 112₁₋₃. In some examples, the POST process may be controlled, for instance, by the BIOS.

In some examples, each PCIe slot 112 may be individually interrogated (or “trained”) to ascertain the capabilities of the modular component 230 installed therein. With the information gained through this interrogation, circuitry 222 may allocate the sixteen (x16) shared bus lanes 106. There are sixteen total shared bus lanes 106 available between PCIe root complex 104 and multiplexor 108, and any one of PCIe slots 112₁₋₃ can use as many as sixteen lanes locally. Assuming the graphics card installed in third PCIe slot 112₃ has a usable range from sixteen lanes (x16) to, say, eight lanes (x8), in some examples, circuitry 222 may cause the sixteen shared bus lanes 106 to be allocated as follows. Four shared lanes (x4) may be allocated to each of first PCIe slot 112₁ and second PCIe slot 112₂. This enables the NVMe 230₁ and NIC 230₂ to operate at full capacity.

Meanwhile, third PCIe slot 112₃ is allocated eight lanes (x8), rather than its possible sixteen, because while likely not optimal, the graphics card 230₃ may be run using as few as eight lanes (x8). Assuming the user of system 200 places higher priority on reducing storage bottlenecks locally and network communication, the resulting degradation in graphics card performance may be acceptable.

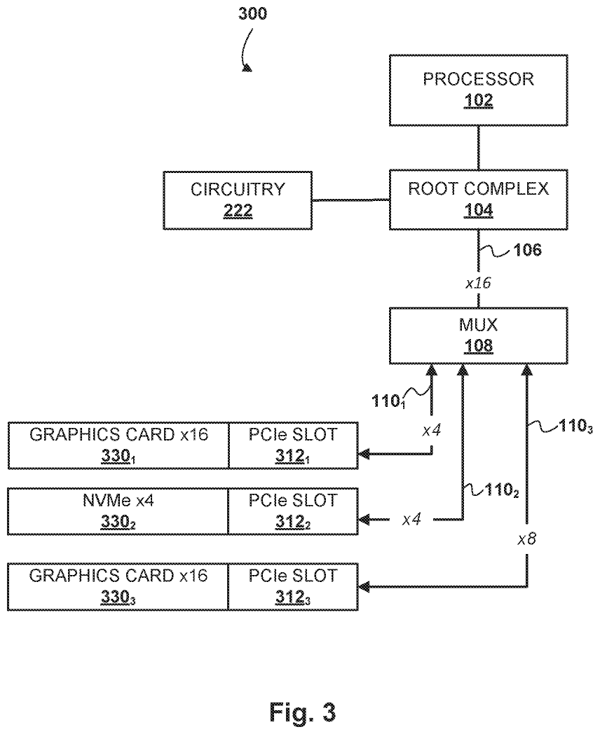

Not all peripheral component slots (e.g., 112₁₋₃) are the same. In many examples, different peripheral component slots support different numbers of lanes locally, and/or may support different transmission speeds. FIG. 3 depicts one such example system 300. System 300 includes many of the same components as system 100 of FIG. 1 and system 200 of FIG. 2. However, different PCI slots 312₁₋₃ in this example have different capabilities.

A first PCIe slot 312₁ is closest physically to PCIe root complex 104. Consequently, first PCIe slot 312₁ is able to support the fastest transmission speeds of all three PCIe slots 312₁₋₃. For example, it can be assumed that first PCIe slot 312₁ supports up to fifth generation PCIe speeds of 32 GT/s per lane. By contrast, second and third PCIe slots 112₂₋₃ may only support up to fourth generation PCIe speeds of 16 GT/s per lane.

Also, different modular components are installed in PCIe slots 312₁₋₃ than in previous examples. In FIG. 3, two graphics cards 330₁ and 330₃ are installed in, respectively, PCIe slot 312₁ and PCIe slot 312₃. Each uses up to sixteen lanes (x16) by default. Another NVMe card 330₂ is installed in second PCIe slot 312₂ and uses four lanes (x4) by default.

In the scenario of FIG. 3, the interrogation of PCIe slots 312₁₋₃ may again be completed as described previously, e.g., during POST. However, in this example, circuitry 222 may attempt to dynamically allocate the sixteen shared lanes 106 to the graphics cards 330_{1, 3} so that they operate with as much bandwidth as possible. In this case, second PCIe slot 312₂ can be allocated, e.g., by circuitry 222, four lanes because that is all NVMe card 330₂ uses.

The remaining twelve shared bus lanes 106 can be allocated amongst the two graphics cards 330_{1, 3} to optimize graphical performance. For example, the PCIe slot 312₁ in which first graphics card 330₁ is installed is faster (fifth generation) than the PCIe slot 312₃ (fourth generation) in which second graphics card 330₃ is removably installed. Accordingly, circuitry 222 allocates more lanes to third PCIe slot 312₃ to make up for the difference in transmission speed capabilities. In particular, third PCIe slot 312₃ is allocated eight lanes (x8), whereas first PCIe lane 312₁ is allocated four lanes (x4). This may maximize the total graphics performance given the limited number (x16) of shared bus lanes 106 after four lanes are allocated to PCIe slot 312₂. Both graphics cards will receive 128 GT/s of bandwidth.

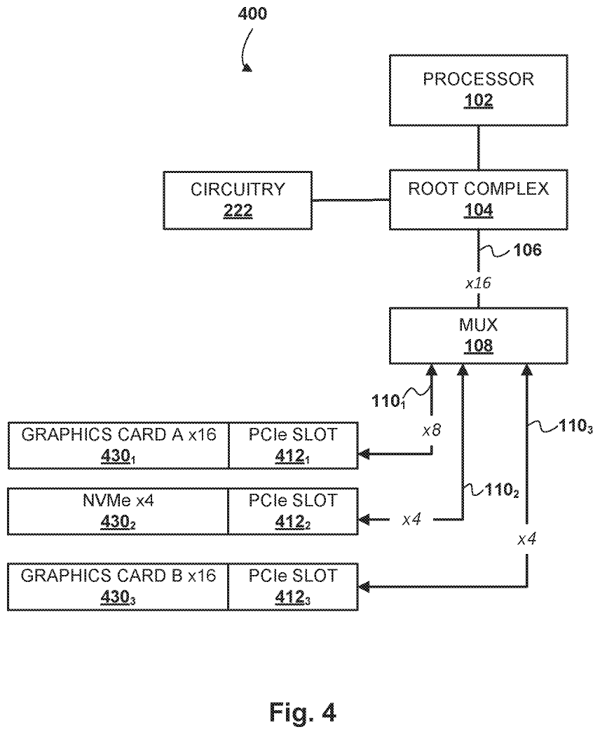

As noted previously, in some examples, a priori and/or a posteriori knowledge about installed modular components' performances may be leveraged to determine how to dynamically allocated shared bus lanes among them. FIG. 4 depicts one such example system 400. System 400 includes many of the same components as systems 100-300 of FIGS. 1-3.

Similar to FIG. 3, in FIG. 4, two graphics cards 430₁ (type A) and 430₃ (type B) are installed in, respectively, PCIe slot 412₁ and PCIe slot 412₃. Each uses up to sixteen lanes (x16) by default. Another NVMe card 4302 is installed in second PCIe slot 412₂ and uses four lanes (x4) by default. As before, the modular components 430₁₋₃ can be interrogated, e.g., during POST, to determine their lane and/or transmission speed capabilities.

In addition, it is known that first graphics card 430₁, by virtue of its being a type “A” graphics card, utilizes resources more efficiently than second graphics card 430₃ (which is type “B”).” This knowledge may be retrieved from, for instance, a lookup table that includes weighted utilization scores for various modular components. In some examples, circuitry 222 may iterate through and calculate a total performance score for each different allocation permutation of graphics cards 430₁ and 430₃. Circuitry 222 may then configure multiplexor 108 with the permutation that resulted in the greatest performance score. For example, in FIG. 4, first PCIe slot 412₁ in which first graphics card 430₁ is installed is allocated eight shared bus lanes 106. Third PCIe slot 412₃ in which second graphics card 430₃ is installed is allocated four shared bus lanes 106.

In addition to or instead of transmission speed capabilities, usable ranges of lanes, a priori and/or a posteriori knowledge about modular components' performances, in some examples, historical usage of modular components in a particular computer system, by a particular user workload, and/or across a population of user workloads may be considered. In FIG. 4, for instance, instead of the allocation being based on knowledge of how graphics cards 430₁ and 430₃ perform in general, the allocation may be based on may be based on observed utilization of these graphics cards over time, e.g., in system 400, by a particular user workload, by a particular installed software application, and/or across a population.

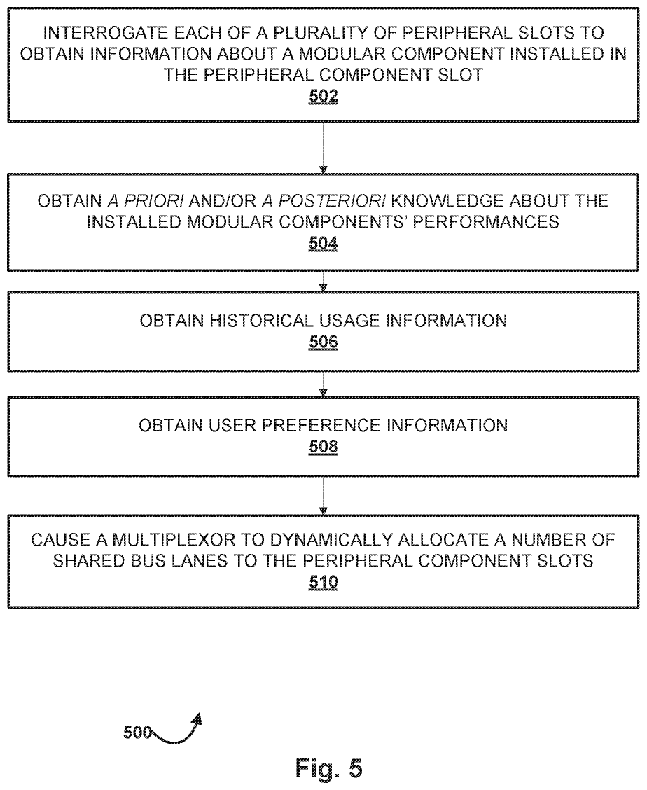

FIG. 5 illustrates a flowchart of an example method 500 for practicing selected aspects of the present disclosure. The operations of FIG. 5 can be performed by, for instance, circuitry 122 or 222, which may include processor 102 (executing instructions in memory) and/or other hardware such as an FPGA or ASIC. For convenience, operations of method 500 will be described as being performed by a system configured with selected aspects of the present disclosure. Other implementations may include additional operations than those illustrated in FIG. 5, may perform operation(s) of FIG. 5 in a different order and/or in parallel, and/or may omit operation(s) of FIG. 5.

At block 502, the system may interrogate each of a plurality of peripheral slots to obtain information about a modular component installed in the peripheral component slot. As noted previously, this interrogation may occur in some examples during POST. In various examples, this information about the modular component may include a usable range of bus lanes and/or a transmission speed capability.

At block 504, the system may obtain a priori and/or a posteriori knowledge about the installed modular components' performances. For example, circuitry 122/222 may consult a lookup table that includes weighted utilization scores for at least some of the installed modular components. From these weighted utilization scores, the system may calculate total performance scores for a variety of different permutations and/or combinations of the installed modular components.

At block 506, the system may obtain historical usage information about the installed modular components, the computing system in which they are installed, and/or the user that operates the computing system. For example, resource utilization may be tracked over time for a computing system using an initial allocation of shared bus lanes. Eventually it may become clear that in the system in question, some modular components are relied on more extensively than others. In some such cases (and where permissible), the more relied-upon modular components may be allocated additional shared bus lanes, e.g., at the expense of lesser-relied-upon modular components.

Similar historical usage information may be applied on a user-by-user basis as well. For example, suppose a particular workstation with a particular combination of modular components installed is used by two users, a robot technician and data scientist. The robot technician may more heavily utilize network bandwidth in order to interact with robot(s), whereas the data scientist may rely upon graphics cards (“GPUs”) to perform artificial intelligence-based computation. Accordingly, when the robot technician is logged in, dynamic allocation may favor a NIC modular component. When the data scientist is logged in, dynamic allocation may favor a graphics card, particularly one that is known (e.g., from a priori and/or a posteriori knowledge obtained at block 504) to be well-suited for artificial intelligence (e.g., “deep learning”) calculations.

At block 508, the system may obtain user preference information. User preference information may include explicitly-defined user preferences for how shared bus lanes should be allocated amongst a plurality of peripheral component slots. In some examples, user preference information may be the strongest signal as to how shared bus lanes should be dynamically allocated.

At block 510, the system may cause multiplexor 108 to dynamically allocate a number of shared bus lanes 106 to the respective pluralities 110 of peripheral bus lanes of the peripheral component slots. This dynamic allocation may be based on, for instance, the usable ranges and transmission speed capabilities of the installed modular components obtained at block 502, the a priori and/or a posteriori knowledge about the modular components obtained at block 504, the historical usage information obtained at block 506, and/or the user preference information obtained at block 508. Alternatively, in some examples, the system may generate audible and/or visual output that is provided to a user to recommend particular allocations. The user can then accept or reject these recommendations.

In some examples, shared bus lanes (106) may be dynamically allocated using other parameters as well. In some examples, shared bus lanes may be allocated on a first-come-first-served basis. Circuitry 112/222 may interrogate each slot as described previously. The first interrogated slot may end up with a certain number of lanes allocated (e.g., via multiplexor 108), and then circuitry 112/222 may move on to interrogating the next slot with the remaining budget of shared bus lanes. This may continue until all slots have been interrogated, or until the shared bus lanes have been allocated.

In some examples, circuitry 122/222 can identify when modular components are not installed in slots, and can optimize shared bus lane utilization accordingly. For instance, there may be both slot(s) that share PCIe resources from multiplexor 108 and slots that have statically assigned resources. When a modular component is installed in a slot that has a static resource allocation, but there is a slot with shared resources that could provide better performance, circuitry 122/222 may alert a user of a potential configuration change.

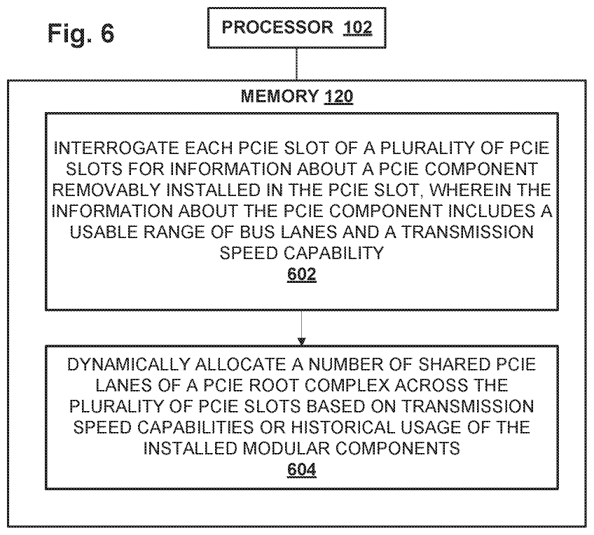

FIG. 6 depicts an example computer-readable medium with instructions to carry out selected aspects of the present disclosure. In particular, memory 120 stores instructions 602-604 that are executable by processor 102 to perform selected aspects of the present disclosure.

Instruction(s) 602 causes processor 102 to interrogate each PCIe slot of a plurality of PCIe slots for information about a PCIe component removably installed in the PCIe slot. In various examples, the information about the PCIe component includes a usable range of bus lanes and a transmission speed capability.

Instruction(s) 604 causes processor 102 to dynamically allocate a number of shared PCIe lanes of a PCIe root complex across the plurality of PCIe slots based on transmission speed capabilities or historical usage of the installed modular components. In various examples, the number of shared PCIe lanes are dynamically allocated by re-rerouting a multiplexor.

In various examples, a system such as a PCA or computing device may include: a peripheral component bridge that provides a number of shared bus lanes; a multiplexor operably coupled with the bridge via the shared bus lanes; a plurality of peripheral component slots, each operably coupled with the multiplexor via a respective plurality of peripheral bus lanes, wherein the multiplexor multiplexes the shared bus lanes to multiple different peripheral component slots; and circuitry to: interrogate each of the peripheral slots to obtain information about a modular component installed in the peripheral component slot, wherein the information about the modular component includes a usable range of bus lanes and a transmission speed capability; and cause the multiplexor to dynamically allocate the number of shared bus lanes to the respective pluralities of peripheral bus lanes of the peripheral component slots based on the usable ranges and transmission speed capabilities of the installed modular components.

In some examples, the peripheral component bridge, multiplexor, and at least some of the peripheral component slots are disposed on a printed circuit assembly. In some examples, the peripheral component bridge comprises a PCIe root complex, and the plurality of peripheral component slots comprise PCIe slots. In some examples, the circuitry is to cause the multiplexor to dynamically allocate the number of shared bus lanes further based on respective transmission speed capabilities of the plurality of peripheral component slots.

In some examples, the circuitry is to cause the multiplexor to dynamically allocate the number of shared bus lanes further based on historical usage data associated with each of the modular components. In some examples, the circuitry is to cause the multiplexor to dynamically allocate the number of shared bus lanes further based on respective roles of each of the modular components.

In some examples, a goal of the dynamic allocation is to maximize bandwidth utilization between each of the plurality of installed modular components and the peripheral component bridge. In some examples, a goal of the dynamic allocation is to maximize bandwidth utilization between a selected one of the plurality of installed modular components and the peripheral component bridge. In some examples, to interrogate a given peripheral slot for information, the circuitry is to temporarily allocate all of the shared bus lanes to the given peripheral slot and apply power to the temporarily-allocated shared lanes to count a number of electrical connections made with the modular component installed in the given peripheral slot.

Additionally, in some examples, an apparatus or system may include: a number of communal peripheral component interface express (“PCIe”) lanes; a plurality of PCIe slots that each includes a plurality of local PCIe lanes, wherein a total number of local PCIe lanes across the plurality of PCIe slots exceeds the number of communal PCIe lanes; and routing circuitry to dynamically allocate the communal PCIe lanes amongst the plurality of PCIe slots based on historical usage data associated with hardware components removably inserted into the plurality of PCIe slots. In some examples, the routing circuitry is to dynamically allocate the communal PCIe lanes amongst the plurality of PCIe slots further based on respective transmission speed capabilities of the hardware components removably inserted into the plurality of PCIe slots.

In some examples, the routing circuitry is to dynamically allocate the communal PCIe lanes amongst the plurality of PCIe slots further based on respective ranges of local PCIe lanes usable by the hardware components removably inserted into the plurality of PCIe slots. In some examples, the routing circuitry includes a processor and a multiplexor.

In another aspect, a computer-readable (transitory or non-transitory) medium may include instructions that, in response to execution of the instructions by a processor, cause the processor to: interrogate each peripheral component interface express (“PCIe”) slot of a plurality of PCIe slots for information about a PCIe component removably installed in the PCIe slot, wherein the information about the PCIe component includes a usable range of bus lanes and a transmission speed capability; and dynamically allocate a number of shared PCIe lanes of a PCIe root complex across the plurality of PCIe slots based on transmission speed capabilities or historical usage of the installed modular components. In some such examples, the number of shared PCIe lanes are dynamically allocated by re-rerouting a multiplexor.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What is claimed is:

1. A system, comprising:
a peripheral component bridge that provides a number of shared bus lanes;
a multiplexor operably coupled with the bridge via the shared bus lanes;
a plurality of peripheral component slots, each operably coupled with the multiplexor via a respective plurality of peripheral bus lanes, wherein the multiplexor multiplexes the shared bus lanes to multiple different peripheral component slots; and
circuitry to:
interrogate each peripheral component slot of the peripheral component slots to obtain information about a modular component installed in the peripheral component slot, wherein the information about the modular component includes a usable range of bus lanes and a transmission speed capability; and
cause the multiplexor to dynamically allocate the number of shared bus lanes to the respective pluralities of peripheral bus lanes of the peripheral component slots based on the usable ranges and transmission speed capabilities of the installed modular components.

2. The system of claim 1, wherein the peripheral component bridge, multiplexor, and at least some of the peripheral component slots are disposed on a printed circuit assembly.

3. The system of claim 1, wherein the peripheral component bridge comprises a peripheral component interface express (“PCIe”) root complex, and the plurality of peripheral component slots comprise PCIe slots.

4. The system of claim 1, wherein the circuitry is to cause the multiplexor to dynamically allocate the number of shared bus lanes further based on respective transmission speed capabilities of the plurality of peripheral component slots.

5. The system of claim 1, wherein the circuitry is to cause the multiplexor to dynamically allocate the number of shared bus lanes further based on historical usage data associated with each of the modular components.

6. The system of claim 1, wherein the circuitry is to cause the multiplexor to dynamically allocate the number of shared bus lanes further based on respective roles of each of the modular components.

7. The system of claim 1, wherein a goal of the dynamic allocation is to maximize bandwidth utilization between each of the plurality of installed modular components and the peripheral component bridge.

8. The system of claim 1, wherein a goal of the dynamic allocation is to maximize bandwidth utilization between a selected one of the plurality of installed modular components and the peripheral component bridge.

9. The system of claim 1, wherein to interrogate a given peripheral component slot for information, the circuitry is to temporarily allocate all of the shared bus lanes to the given peripheral component slot and apply power to the temporarily-allocated shared lanes to count a number of electrical connections made with the modular component installed in the given peripheral component slot.

10. An apparatus comprising:
a number of communal peripheral component interface express (“PCIe”) lanes;
a plurality of PCIe slots that each includes a plurality of local PCIe lanes, wherein a total number of local PCIe lanes across the plurality of PCIe slots exceeds the number of communal PCIe lanes; and
routing circuitry to dynamically allocate the communal PCIe lanes amongst the plurality of PCIe slots based on historical usage data associated with hardware components removably inserted into the plurality of PCIe slots.

11. The apparatus of claim 10, wherein the routing circuitry is to dynamically allocate the communal PCIe lanes amongst the plurality of PCIe slots further based on respective transmission speed capabilities of the hardware components removably inserted into the plurality of PCIe slots.

12. The apparatus of claim 10, wherein the routing circuitry is to dynamically allocate the communal PCIe lanes amongst the plurality of PCIe slots further based on respective ranges of local PCIe lanes usable by the hardware components removably inserted into the plurality of PCIe slots.

13. The apparatus of claim 10, wherein the routing circuitry includes a processor and a multiplexor.

14. A non-transitory computer-readable medium comprising instructions that, in response to execution of the instructions by a processor, cause the processor to:
interrogate each peripheral component interface express (“PCIe”) slot of a plurality of PCIe slots for information about a PCIe component removably installed in the PCIe slot, wherein the information about the PCIe component includes a usable range of bus lanes and a transmission speed capability; and
dynamically allocate a number of shared PCIe lanes of a PCIe root complex across the plurality of PCIe slots based on transmission speed capabilities or historical usage of the installed modular components.

15. The non-transitory computer-readable medium of claim 14, wherein the number of shared PCIe lanes are dynamically allocated by re-rerouting a multiplexor.
